(19) United States
(12) Patent Application Publication
(10) Pub. No.: US 2004/0122989 A1
(43) Pub. Date: Jun. 24, 2004

(54) Method of determining code to download for runtime configuration

(76) Inventors: Lyman Hall, Nampa, ID (US); Melvin Dirk Bodily, Boise, ID (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/327,350

(22) Filed: Dec. 20, 2002

(51) Int. Cl. G06F 13/10

(52) U.S. Cl. 710/8

(57) ABSTRACT

In a system that includes a host computer and a peripheral device, a command code program monitors the I/O interfaces for changes in device state. When a device function is required, a message is sent to the host computer for a download of the code necessary to execute the requested function. The code is downloaded and executed by the peripheral device. When the function completes, the device function code is removed and command code continues monitoring the system.

### BACKGROUND

Most peripheral computer devices, e.g. printers, facsimile machines, and monitoring devices, are offering more functions and capability. Many of the functions are used infrequently yet the functionality must be present in the current code base. Currently, all the code is stored in the device taking read-only memory (ROM) and read-access memory (RAM) space. As shown in FIG. 1, the command codes reside permanently. The code is copied to RAM to improve performance. The resulting systems are often expensive because of ROM and RAM requirements. Often, this leaves less RAM available for working buffers. They further lack modularity.

### SUMMARY

In the present invention, the sole code resident on the device is command code. The command code monitors the I/O interfaces for changes in states. When a function is required, a message is sent to the microprocessor for a download of the code necessary to execute the requested function. The code is downloaded and executed. When the function completes, the code is removed and command code continues monitoring the system.

### BRIEF DESCRIPTION OF THE DRAWINGS

FIG. 1 illustrates a block diagram of the prior art.

FIG. 2 illustrates a block diagram according to the present invention.

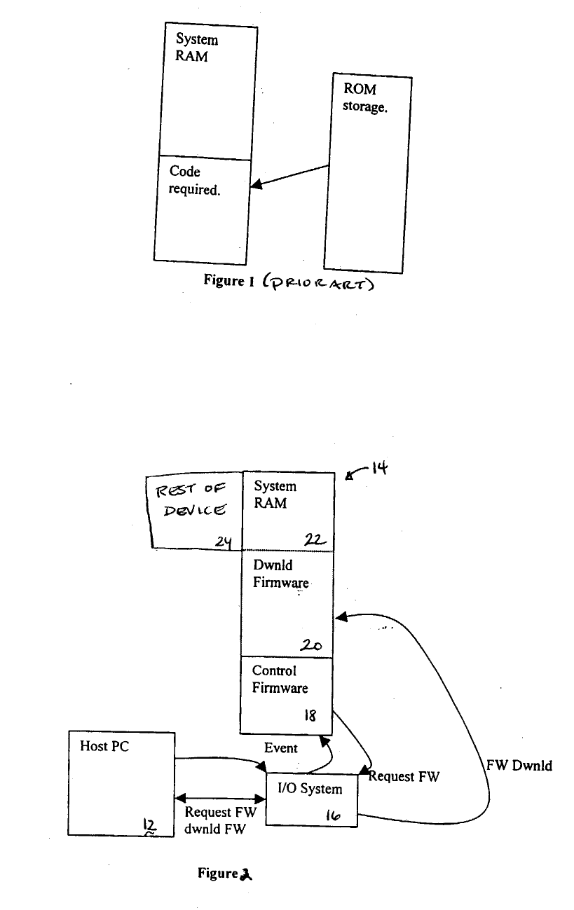

### DETAILED DESCRIPTION

In the present invention, a command code program monitors the I/O interfaces for changes in states. When a function is required, a message is sent to the microprocessor for a download of the code necessary to execute the requested function. The code is downloaded and executed. When the function completes, the code is removed and command code continues monitoring the system.

FIG. 2 illustrates a system block diagram (10) according to the present invention. A host computer (12) communicates with a peripheral device (14) through an I/O system (16). The peripheral device (14) includes control firmware (18) that resides in Read-Only Memory (ROM), device Read-Access Memory (RAM) (20), system RAM (22), and the rest of the peripheral device (24).

The “command code” for the peripheral device (14) is stored on the host computer (12). The host computer (12) monitors the I/O system (16) for changes in state. When a function is required, a message is sent from the control firmware (18) to the host computer (12) via the I/O system (16) for a download of the command code necessary to execute the requested function. After checking the downloaded firmware for the correct cyclical redundancy check (CRC), the control firmware (18) passes control to the device RAM 20. The command code is downloaded into the device RAM (20) and executed. When the function completes, the command code is removed from the peripheral device (14) and the host computer (12) continues to monitor the system.

The peripheral device (14) has minimal ROM and RAM requirements as the command code does not reside on the device. The command program that simply monitors the interfaces, may reside in the host computer (12) or in the peripheral device (14). Added device functionality is easy to update as it requires a simple download to the host computer.

1. A system comprising:
a host device including peripheral function code;
a peripheral device including,
read-only memory (ROM) that includes control firmware which generates requests for peripheral function code,
device read-access memory (RAM), and
system RAM;
an I/O system connecting between the host device and the peripheral device; and
peripheral monitoring code, resident on one of the host device and peripheral device, when a request for peripheral function code is detected, the peripheral function code is downloaded to the device RAM.

2. A system, as defined in claim 1, wherein the peripheral monitoring code resides on the host device.

3. A system, as defined in claim 1, wherein the peripheral monitoring code resides on the peripheral device.

4. A method for providing device function code comprising:
requesting device function code from a host device;
a peripheral device receiving and storing the device function code;
executing the device function code; and
erasing the device function code after execution.

5. A method, as defined in claim 4, further including checking the validity of the device function code before executing.

6. A method, as defined in claim 4, further comprising monitoring for a request for device function code before requesting.

7. A method, as defined in claim 4, wherein requesting is done by the host device.

8. A method, as defined in claim 4, wherein requesting is done by the peripheral device.
